(19) United States
(12) Patent Application Publication
(10) Pub. No.: US 2010/0239929 A1
(43) Pub. Date: Sep. 23, 2010

(54) FUEL CELL SYSTEM

(76) Inventors: Shigeto Kajiwara, Okazaki-shi (JP); Yasuhiro Nonobe, Nishikamo-gun (JP); Shinji Aso, Toyota-shi (JP)

Correspondence Address: KENYON & KENYON LLP, 1500 K STREET N.W., SUITE 700, WASHINGTON, DC, 20005, US

(21) Appl. No.: 12/294,717

(22) PCT Filed: Nov. 22, 2007
(86) PCT No.: PCT/JP2007/073123

§ 371 Date: Sep. 26, 2008

(30) Foreign Application Priority Data
Dec. 13, 2006 (JP) 2006-336088

(51) Int. Cl. H01M 8/04

(52) U.S. Cl. 429/431; 429/442

(57) ABSTRACT

A fuel cell system has a fuel cell stack generating electricity with a reactive gas supplied thereto and a controller supplying to the fuel cell stack the reactive gas whose pressure is higher than a normal operational pressure on condition that a temperature of the fuel cell stack is equal to or less than a predetermined threshold temperature and that a moisture content of the fuel cell stack is equal to or less than a predetermined threshold value. Where a supply pressure of the reactive gas is raised, an amount of moisture taken away by the reactive gas becomes less, and thus, water balance within the fuel cell stack shifts toward accumulation of moisture contained in the reactive gas into the film-electrode joined body. However, since the moisture content of the fuel cell stack is equal to or less than the predetermined threshold value, the system can improve the starting performance of the fuel cell stack at low temperature while suppressing flooding.

### TECHNICAL FIELD

This invention relates to a fuel cell system having a fuel cell stack generating electricity with a reactive gas supplied thereto.

### BACKGROUND ART

A fuel cell stack has a stack structure formed by stacking multiple cells in series, and each of the cells has film-electrode joined body formed by arranging an anode electrode on one side of an electrolyte film and a cathode electrode on the other side thereof. By supplying a reactive gas to the film-electrode joined body, an electrochemical reaction proceeds to convert chemical energy into electrical energy. Especially, a solid polymer electrolyte fuel cell stack using a solid polymer film as an electrolyte can be made smaller at low cost and has a high power density, and therefore the stack is expected to be used as a car-mounted electric power source.

Since a cell reaction of the fuel cell system generates moisture, there exists a possibility that the moisture might freeze on an electrode catalyst, a gas diffusion layer, and the like under low temperature environment such as below-freezing and the like. Further, under such low temperature environment, a saturation vapor pressure of air decreases, thereby increasing a moisture content of the film-electrode joined body. In such state, an electrode reaction area decreases to significantly deteriorate diffusion performance of the reactive gas, and in some cases, the fuel cell system fails to output nominal electromotive force. To address such problems, Japanese Patent Laid-Open No. 2005-44795 discloses the improvement of electric power generation characteristic by performing control to make the pressure of the reactive gas supplied to the fuel cell stack higher when starting the fuel cell under the below-freezing point than a normal operational pressure. Where a supply pressure of the reactive gas is made higher, the reactive gas can be forcibly supplied to a three-phase interface on which the electrochemical reaction proceeds, thus compensating for deterioration of the gas diffusion performance caused by deterioration of catalytic activity and freezing of the generated water.

### [Patent Document 1] Japanese Patent Laid-Open No. 2005-44795

### DISCLOSURE OF THE INVENTION

However, where the supply pressure of the reactive gas is raised, an amount of moisture taken away by the reactive gas becomes less, and thus, water balance within the fuel cell stack shifts toward accumulation of moisture contained in the reactive gas into the film-electrode joined body. In a state where moisture sufficient for ensuring a proton conductivity needed for power generation is contained in the film-electrode joined body when starting the fuel cell at low temperature, a raise in the supply pressure of the reactive gas causes flooding, and may deteriorate output characteristic of the fuel cell stack due to increase in concentration polarization caused by deterioration of the diffusion performance of the reactive gas.

The present invention is made to solve such problems, and aims to improve starting performance of the fuel cell stack at low temperature.

To solve the above problems, a fuel cell system of the present invention has a fuel cell stack for generating electricity with a reactive gas supplied thereto, and a reactive gas supply control device for supplying to the fuel cell stack a reactive gas whose pressure is higher than a normal operational pressure on condition that a temperature of the fuel cell stack is equal to or less than a predetermined threshold temperature and that a moisture content of the fuel cell stack is equal to or less than a predetermined threshold value.

Where the moisture content of the fuel cell stack is equal to or less than the predetermined threshold value, the reactive gas whose pressure is higher than the normal operating pressure is supplied to the fuel cell stack, thus achieving improvement of the starting performance of the fuel cell stack at low temperature while suppressing flooding.

The reactive gas supply control device supplies to the fuel cell stack the reactive gas whose pressure is higher than the normal operating pressure on condition that an electric power generation request electric current with respect to the fuel cell stack is more than a maximum electric current capable of being outputted by the fuel cell stack.

When the electric power generation request electric current with respect to the fuel cell stack is more than the maximum electric current capable of being outputted by the fuel cell stack, the reactive gas whose pressure is higher than the normal operating pressure is supplied to the fuel cell stack, thus achieving improvement of maximum output characteristic of the fuel cell stack.

The reactive gas supply control device supplies to the fuel cell stack the reactive gas whose pressure is made higher as the moisture content of the fuel cell stack becomes less.

The applicant of the invention has confirmed through experiment that the output characteristic of the fuel cell stack is greatly improved where the fuel cell stack is supplied with the reactive gas whose pressure is made higher, compared with the normal operating pressure, as the moisture content of the fuel cell stack becomes less.

### BRIEF DESCRIPTION OF THE DRAWINGS

FIG. 1 is a system configuration diagram of the fuel cell system according to the present embodiment;

FIG. 2 is a flowchart showing a low temperature starting processing routine according to the present embodiment;

FIG. 3 is a graphic chart showing relationship between an alternating-current impedance and a maximum output;

FIG. 4 is map data showing I-V characteristic of the fuel cell stack;

FIG. 5 is map data showing P-I characteristic of the fuel cell stack; and

FIG. 6 is map data showing relationship between an oxidation gas back pressure instruction value and an alternating-current impedance.

### BEST MODE FOR CARRYING OUT THE INVENTION

The embodiment of the present invention is hereinafter described with reference to each figure.

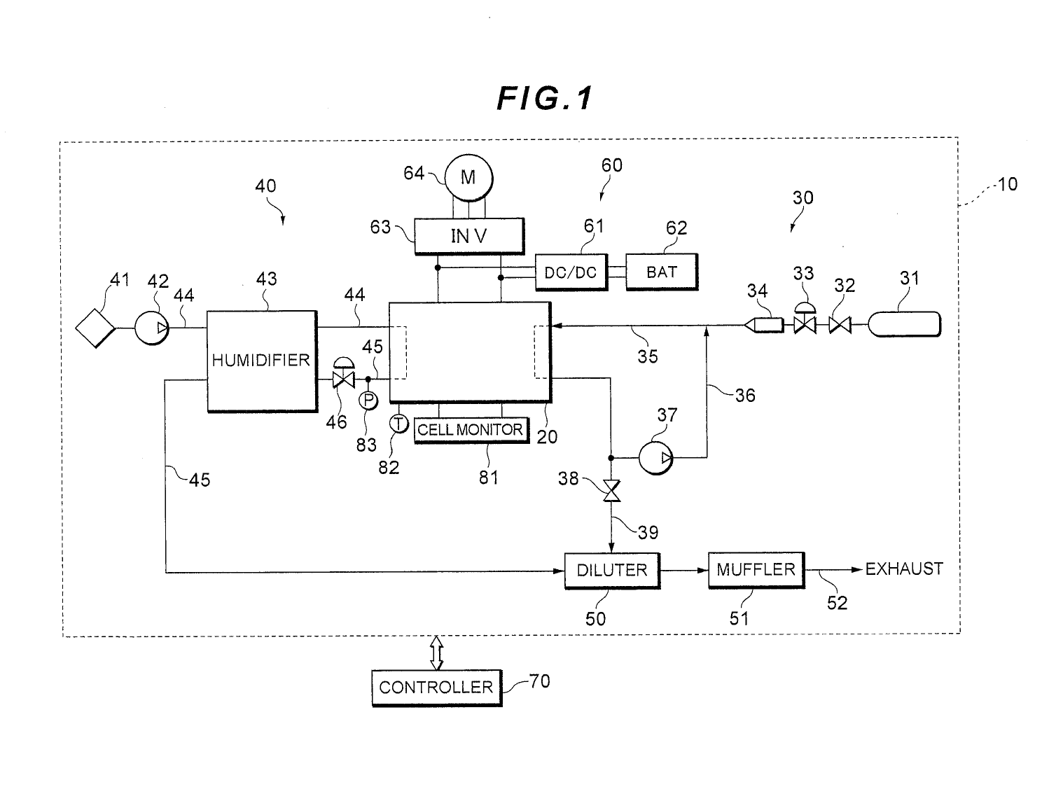

FIG. 1 shows a system configuration of a fuel cell system 10 functioning as a car-mounted electric power source system for a fuel cell vehicle.

The fuel cell system 10 has a fuel cell stack 20 generating electricity with a reactive gas (an oxidation gas and a fuel gas) supplied thereto, a fuel gas piping system 30 supplying a hydrogen gas as the fuel gas to the fuel cell stack 20, an oxidation gas piping system 40 supplying air as the oxidation gas to the fuel cell stack 20, an electric power system 60 controlling charging and discharging of electric power, and a controller 70 integrally controls the entire system.

The fuel cell stack 20 is, for example, a solid polymer electrolyte cell stack formed by stacking many cells in series. A cell has a cathode electrode on one side of an electrolyte film made of an ion exchange film, an anode electrode on the other side thereof, and further a pair of separators sandwiching the cathode electrode and the anode electrode from both sides thereof. The fuel gas is supplied to a fuel gas flow path of one separator, and the oxidation gas is supplied to an oxidation gas flow path of the other separator, and thus, these gas supplies cause the fuel cell stack 20 to generate electricity.

In the fuel cell stack 20, an oxidation reaction according to formula (1) occurs on the anode electrode, and a reductive reaction according to formula (2) occurs on the cathode electrode. As a whole, electric power generation reaction according to formula (3) occurs in the fuel cell stack 20.

H₂->2H⁺+2e⁻ (1)

(½)O₂+2H⁺+2e⁻->H₂O (2)

H₂+(½)O₂->H₂O (3)

The fuel gas piping system 30 has a fuel gas supply source 31, a fuel gas supply flow path 35 allowing flow of the fuel gas (the hydrogen gas) supplied from the fuel gas supply source 31 to the anode electrode of the fuel cell stack 20, a circulation flow path 36 returning a fuel offgas (a hydrogen offgas) exhausted from the fuel cell stack 20 to the fuel gas supply flow path 35, a circulation pump 37 pneumatically transport the fuel offgas in the circulation flow path 36 to the fuel gas supply flow path 35, and an exhaust flow path 39 connected in a tapping manner to the circulation flow path 36.

The fuel gas supply source 31 is comprised of, for example, a high pressure hydrogen tank, a hydrogen storage alloy, and the like, and stores, for example, a hydrogen gas of 35 MPa or 70 MPa. Upon opening a shut-off valve 32, the hydrogen gas flows out of the fuel gas supply source 31 into the fuel gas supply flow path 35. The pressure of the hydrogen gas is reduced to, for example, about 200 kPa by a regulator 33 and an injector 34, and is supplied to the fuel cell stack 20.

It should be noted that the fuel gas supply source 31 may be comprised of a reforming unit generating a hydrogen-rich reformed gas from a hydrocarbon-type fuel and a high pressure gas tank accumulating, in a high pressure state, the reformed gas generated by the reforming unit.

The injector 34 is an electromagnetic drive type on-off valve capable of adjusting a gas flow rate and a gas pressure by separating a valve disk from a valve seat by directly driving the valve disk with electromagnetic force at a predetermined driving interval. The injector 34 has the valve seat having a jet orifice emitting a jet of a gas fuel such as the fuel gas, a nozzle body supplying and guiding the gas fuel to the jet orifice, and the valve disk contained and held to be able to move with respect to the nozzle body in an axial line direction (a direction of gas flow) and opening and closing the jet orifice.

The exhaust flow path 39 is connected to the circulation flow path 36 via an exhaust valve 38. The exhaust valve 38 operates according to an instruction from a controller 70 to exhaust moisture and the fuel offgas containing impurities in the circulation flow path 36 to the outside. Upon opening of the exhaust valve 38, an impurity concentration in the hydrogen offgas in the circulation flow path 36 decreases, and a hydrogen concentration in the fuel offgas returned and supplied increases.

The fuel offgas exhausted via the exhaust valve 38 and the exhaust flow path 39 and the oxidation offgas flowing in an exhaust flow path 45 flow into a diluter 50, and the diluter 50 dilutes the fuel offgas. An exhaust sound from the diluted fuel offgas is reduced by a muffler (a silencer) 51, and the diluted fuel offgas flows in a tail pipe 52 and is exhausted to the outside of a car.

The oxidation gas piping system 40 has an oxidation gas supply flow path 44 allowing flow of the oxidation gas supplied to the cathode electrode of the fuel cell stack 20 and the exhaust flow path 45 allowing flow of the oxidation offgas exhausted from the fuel cell stack 20. The oxidation gas supply flow path 44 has an air compressor 42 taking in the oxidation gas via a filter 41 and a humidifier 43 humidifying the oxidation gas pneumatically transported by the air compressor 42. The exhaust flow path 45 has a back pressure adjusting valve 46 adjusting an oxidation gas supply pressure (a back pressure of the oxidation gas) and the humidifier 43.

The humidifier 43 contains a vapor permeable membrane bundle (a hollow fiber membrane bundle) made of many vapor permeable membranes (hollow fiber membranes). The highly wet oxidation offgas (wet gas) containing a lot of moisture generated by cell reaction flows into the inside of the vapor permeable membranes, while the lowly wet oxidation gas (dry gas) taken in from the atmosphere flows to the outside of the vapor permeable membranes. The oxidation gas is humidified by performing moisture exchange between the oxidation gas and the oxidation offgas over the vapor permeable membranes.

An electric power system 60 has a DC/DC converter 61, a battery 62, a traction inverter 63, and a traction motor 64. The DC/DC converter 61 is a direct current voltage transducer, and has a function to raise a direct current voltage from the battery 62 and output the voltage to the traction inverter 63 and a function to reduce a direct current voltage from the fuel cell stack 20 or the traction motor 64 and charge the battery 62. Charging and discharging of the battery 62 is controlled by these functions of the DC/DC converter 61. Further, an operational point (an output voltage, an output electric current) of the fuel cell stack 20 is controlled by a voltage transformation control of the DC/DC converter 61.

The battery 62 is an electric storage device capable of storing and discharging electric power, and functions as a regeneration energy storage source when braking with a regeneration and an energy buffer when a load changes due to acceleration or deceleration of the fuel cell vehicle. The battery 62 may preferably be a secondary battery such as, for example, a nickel-cadmium storage battery, a nickel-metal-hydride storage battery, a lithium secondary battery, or the like.

The traction inverter 63 converts a direct current into a three-phase alternating current, and supplies the three-phase alternating current to the traction motor 64. The traction motor 64 is, for example, a three-phase alternating current motor, and constitutes a power source for the fuel cell vehicle.

The controller 70 is a computer system having a CPU, a ROM, a RAM, and an input-output interface, and controls each unit of the fuel cell system 10. For example, upon receiving a starting signal outputted from an ignition switch (not shown), the controller 70 starts operation of the fuel cell system 10, and determines a requested electric power of the entire system based on an accelerator opening degree signal outputted from an accelerator sensor (not shown) and a vehicle speed signal outputted from a vehicle speed sensor (not shown). The requested electric power of the entire system is a summed value of a vehicle moving electric power and an accessory electric power. The accessory electric power includes, for example, an electric power consumed by vehicle accessory devices (a humidifier, an air compressor, a hydrogen pump, a cooling water circulation pump, and the like), an electric power consumed by devices needed for moving the vehicle (a change gear, a wheel control device, a steering device, a suspension device, and the like), and an electric power consumed by devices arranged in a passenger space (an air conditioner, lighting equipment, an audio, and the like).

The controller 70 determines distribution of output electric power of the fuel cell stack 20 and the battery 62, adjusts the number of revolutions of the air compressor 42 and a valve opening degree of the injector 34 to cause an amount of electric power generation of the fuel cell stack 20 to be the same as a targeted electric power, adjusts an amount of supply of the reactive gas to the fuel cell stack 20, and controls the operational point (the output voltage, the output electric current) of the fuel cell stack 20 by controlling the DC/DC converter 61 and adjusting the output voltage of the fuel cell stack 20. Further, to obtain a targeted vehicle speed depending on the accelerator opening degree, for example, the controller 70 outputs alternating current voltage instruction values of each of U-phase, V-phase, and W-phase as a switching instruction to the traction inverter 63 to control an output torque and the number of revolutions of the traction motor 64.

It should be noted that the fuel cell system 10 has a cell monitor 81 detecting a cell voltage, a temperature sensor 82 detecting a stack temperature, a pressure sensor 83 detecting the back pressure of the oxidation gas, and the like, which serve as sensors for detecting operational state of the fuel cell stack 20.

Next, the outline of a low temperature starting processing according to the present embodiment will be hereinafter described.

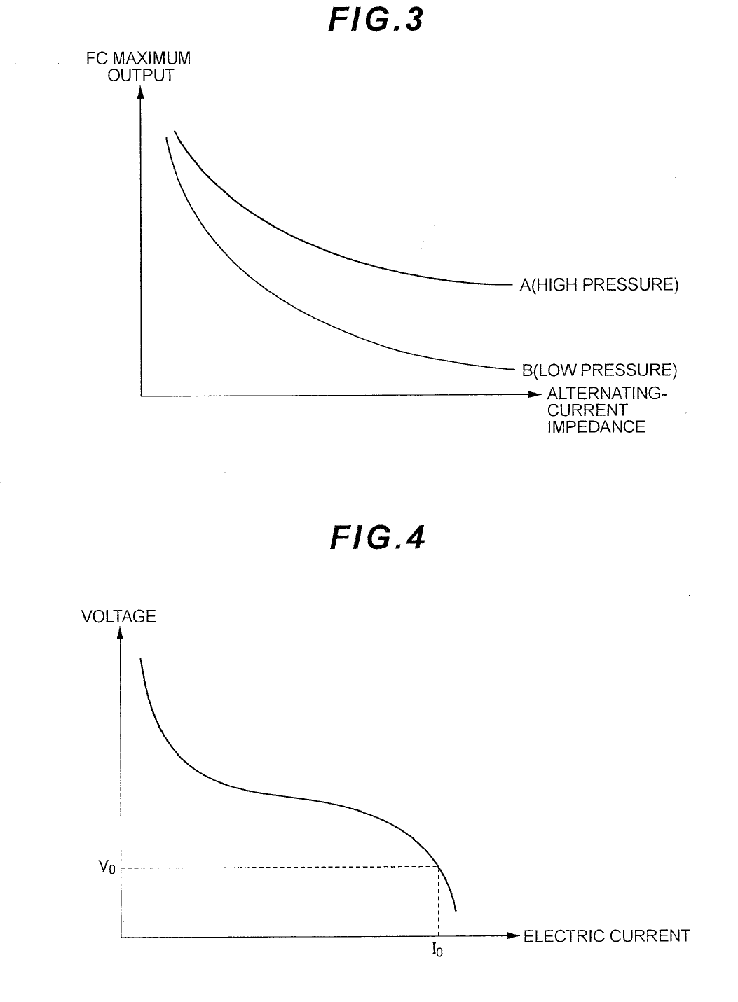

FIG. 3 is a graphic chart showing the improvement in the output characteristic of the fuel cell stack 20 by raising the supply pressure of the reactive gas when starting the fuel cell at low temperature. The horizontal axis shows an alternating-current impedance of the fuel cell stack 20, and the vertical axis shows a maximum output of the fuel cell stack 20. It is known that a degree of proton conduction of the electrolyte film is directly proportional to the amount of moisture contained in the electrolyte film, and thus, the alternating-current impedance can be used as a physical parameter for evaluating a degree of dryness of the film-electrode joined body. A curve A shows a case where the supply pressure of the reactive gas is high pressure (for example, 200 kPa), and a curve B shows a case where the supply pressure of the reactive gas is low pressure (for example, 140 kPa). As this graphic chart shows, it can be understood that the output characteristic can be greatly improved by making the supply pressure of the reactive gas higher, compared with the normal operational pressure, as the alternating-current impedance becomes higher (as the degree of dryness of the film-electrode joined body becomes higher). Further, it can be confirmed that the output characteristic of the fuel cell stack 20 can be greatly improved by making the supply pressure of the reactive gas higher, compared with the normal operational pressure, as the stack temperature becomes lower.

It should be noted that where the stack temperature exceeds a predetermined threshold temperature (for example, 10 degrees Celsius), the difference between the curve A and the curve B hardly exists, and the improvement by raising the supply pressure of the reactive gas is not recognized in the output characteristic of the fuel cell stack 20. If the supply pressure of the reactive gas is raised to even where the improvement is not recognized in the output characteristic of the fuel cell stack 20, the electric power consumption by the accessory devices (such as the air compressor 42) increases to deteriorate overall energy efficiency of the fuel cell system 10, thus being unfavorable.

From the experimental result as described above, in the low temperature starting processing according to the present embodiment, the reactive gas whose pressure is made higher than the normal operational pressure is supplied to the fuel cell stack 20 on condition that the stack temperature is equal to or less than the predetermined threshold temperature and that the moisture content of the film-electrode joined body is equal to or less than the predetermined threshold value (the alternating-current impedance is equal to or more than the predetermined threshold value). Where the supply pressure of the reactive gas is raised, the amount of moisture taken away by the reactive gas becomes less, and thus, water balance within the fuel cell stack shifts toward accumulation of moisture contained in the reactive gas into the film-electrode joined body. In a state where the film-electrode joined body is dry, even if the raised supply pressure of the reactive gas causes moisture to accumulate in the film-electrode joined body, there is not a possibility that an increase in concentration polarization caused by flooding causes deterioration in the output characteristic of the fuel cell stack 20.

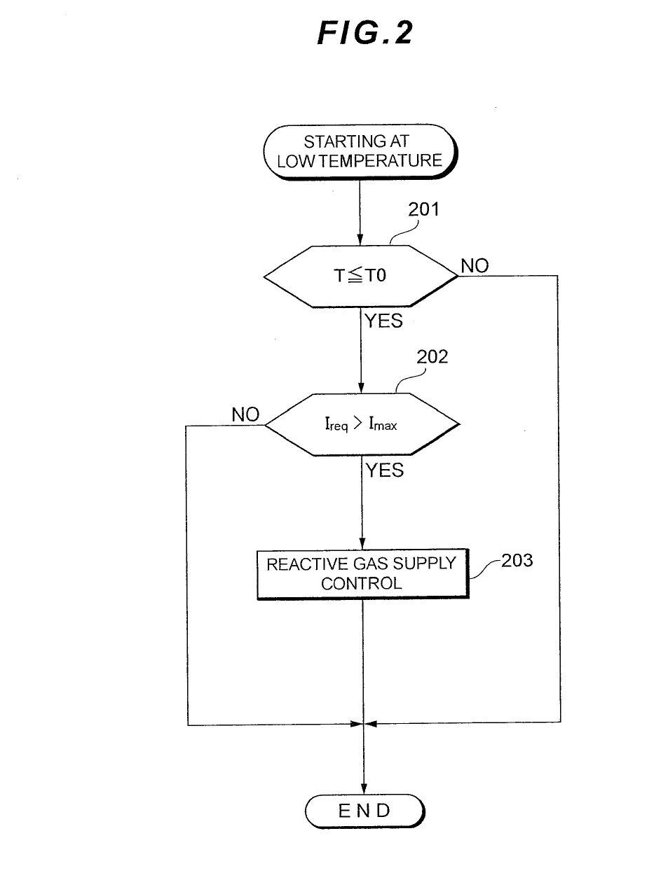

Next, the detail of the low temperature starting processing according to the present embodiment is hereinafter described with reference to FIG. 2 to FIG. 6.

FIG. 2 is a flowchart showing the low temperature starting processing routine.

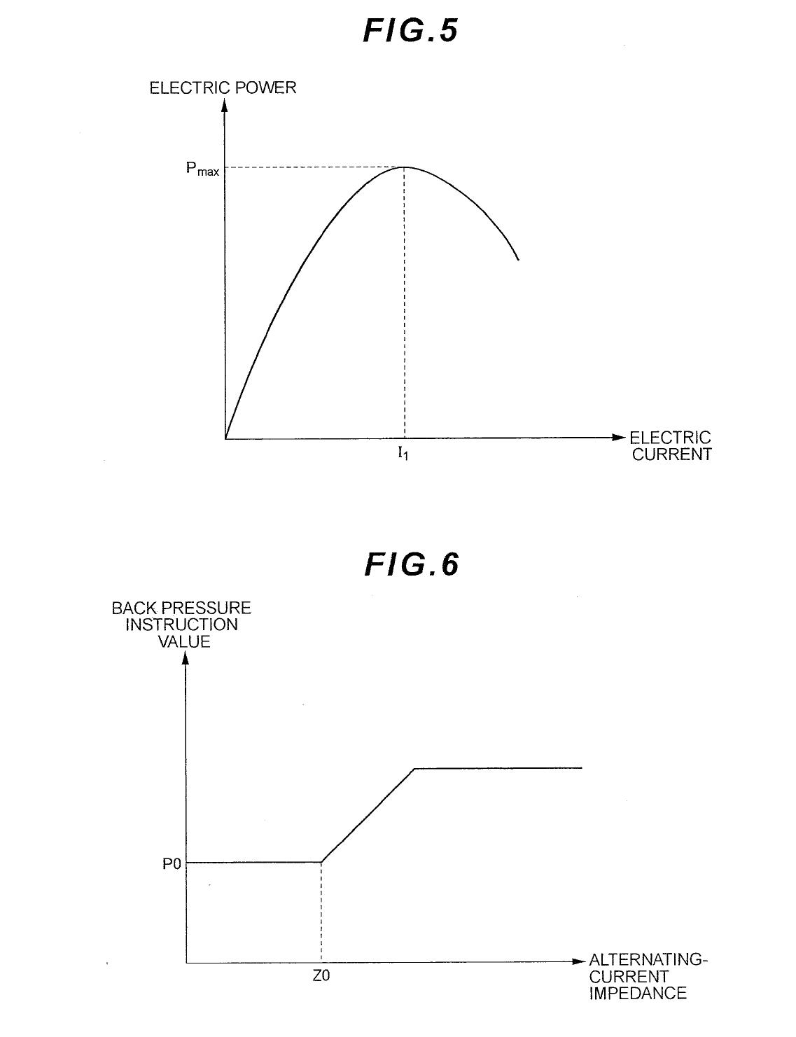

When the ignition switch (not shown) is turned on, the controller 70 calls and executes the low temperature starting processing routine. The controller 70 first reads a detected value of the temperature sensor 82, and makes a determination as to whether a stack temperature T is equal to or less than a predetermined threshold temperature T0 (Step 201). The threshold temperature T0 is preferably set to a maximum value (for example, 10 degrees Celsius) of a temperature that is expected to improve the output characteristic by making the supply pressure of the reactive gas to the fuel cell stack 20 higher than the normal operational pressure.

Where the stack temperature T is more than the threshold temperature T0 (Step 201; NO), the controller 70 gets out of the low temperature starting processing routine, and executes a normal starting processing routine (not shown).

Where the stack temperature T is equal to or less than the threshold temperature T0 (Step 201; YES), the controller 70 makes a determination as to whether a requested electric current value I_{req} is more than a maximum electric current value Iₘₐₓ (Step 202). Herein, the maximum electric current Iₘₐₓ means smaller one of a lowest voltage electric current I₀ and a maximum electric power electric current I₁. The lowest voltage electric current I₀ is an electric current corresponding to a system lowest voltage V₀ on an I-V characteristic curve shown in FIG. 4. The maximum electric power electric current I₁ is an electric current corresponding to a maximum electric power Pₘₐₓ on a P-I characteristic curve shown in FIG. 5.

Where the requested electric current value I_{req} is less than the maximum electric current value Iₘₐₓ (Step 202; NO), the controller 70 gets out of the low temperature starting processing routine, and executes the normal starting processing routine (not shown).

Where the requested electric current value I_{req} is more than the maximum electric current value Iₘₐₓ (Step 202; YES), the controller 70 performs a control to raise the supply pressure of the reactive gas to the fuel cell stack 20 (Step 203).

To raise the supply pressure of the reactive gas, at least the supply pressure of the oxidation gas may be raised, and the pressure of the fuel gas is not necessarily required to be raised. To raise the supply pressure of the oxidation gas, for example, using map data shown in FIG. 6, an oxidation gas back pressure instruction value (a targeted value) corresponding to the alternating-current impedance of the fuel cell stack 20 is calculated, and the number of revolutions of the air compressor 42 and the valve opening degree of the back pressure adjusting valve 46 are adjusted to make the back pressure of the oxidation gas of the fuel cell stack 20 be the same as the targeted value while reading a detected value of the pressure sensor 83.

On the map data shown in FIG. 6, where the alternating-current impedance is less than a predetermined threshold value Z0, the oxidation gas back pressure instruction value agrees with a normal operational pressure P0. Where the alternating-current impedance becomes equal to or more than the predetermined threshold value Z0, the oxidation gas back pressure instruction value rises as the alternating-current impedance increases, and the oxidation gas back pressure instruction value becomes constant after having increased to a certain extent. The reason why the oxidation gas back pressure instruction value becomes a constant value where the alternating-current impedance rises to a certain extent is that consideration is made on gas supplying capability, electric power consumption, and the like of the air compressor 42. Herein, the threshold value Z0 preferably uses the alternating-current impedance when the film-electrode joined body contains an amount of moisture theoretically needed for performing battery operation.

It should be noted that the alternating-current impedance of the fuel cell stack 20 can be measured by controlling the DC/DC converter 61, detecting a change in a response voltage of each cell with a cell monitor 81 while varying a frequency of an alternating-current signal applied to the fuel cell stack 20, and performing calculation of formulas (4) to (6). Formulas (4) to (6) are satisfied where the fuel cell stack 20 has a response voltage E, a response current I, and an alternating-current impedance Z when the alternating-current signal is applied to the fuel cell stack 20.

E=E_{SEL}expj(ωt+φ) (4)

I=I_{SEL}expjωt (5)

Z=E/I=(E_{SEL}/I_{SEL})expjφ=R+jχ (6)

Herein, E_{SEL} represents an amplitude of the response voltage, I_{SEL} represents an amplitude of the response electric current, ω represents an angular frequency, φ represents an initial phase, R represents a resistance component (real part), χ represents a reactance component (imaginary part), j represents an imaginary unit, and t represents a time.

Examples described by way of the embodiment of the invention can be appropriately combined depending on usage, or changed or improved, and the present invention is not limited to the description of the embodiment as above.

Although the present embodiment describes operation for making the supply pressure of the reactive gas higher than the normal operational pressure where the requested electric current value I_{req} is more than the maximum electric current value Iₘₐₓ, the present invention is not limited thereto. For example, when the oxidation gas back pressure instruction values determined from relationship between the requested electric current value I_{req}, the stack temperature T, and the alternating-current impedance are prepared in advance through experiment as map data, the supply pressure of the oxidation gas may be controlled by calculating the oxidation gas back pressure instruction value (the targeted value) from the relationship between the requested electric current value I_{req}, the stack temperature T, and the alternating-current impedance.

Although the embodiment as described above exemplifies a usage model using the fuel cell system 10 as a car-mounted electric power source system, the usage model of the fuel cell system 10 is not limited to this example. For example, the fuel cell system 10 may be mounted as an electric power source of a mobile unit other than the fuel cell vehicle (a robot, a ship, an airplane, and the like). Further, the fuel cell system 10 according to the present embodiment may be used as electric power generation equipment in a house, a building, and the like (a fixedly placed electric power generation system).

### INDUSTRIAL APPLICABILITY

The present invention can improve starting performance of a fuel cell stack at low temperature while suppressing flooding by supplying to the fuel cell stack a reactive gas whose pressure is higher than a normal operational pressure.

1. A fuel cell system comprising:
a fuel cell stack for generating electricity with a reactive gas supplied thereto; and
a reactive gas supply control device for supplying to the fuel cell stack the reactive gas whose pressure is higher than a normal operational pressure on condition that a temperature of the fuel cell stack is equal to or less than a predetermined threshold temperature and that a moisture content of the fuel cell stack is equal to or less than a predetermined threshold value.

2. The fuel cell system according to claim 1, wherein the reactive gas supply control device supplies to the fuel cell stack the reactive gas whose pressure is higher than the normal operating pressure on condition that an electric power generation request electric current with respect to the fuel cell stack is more than a maximum electric current capable of being outputted by the fuel cell stack.

3. The fuel cell system according to claim 1, wherein the reactive gas supply control device supplies to the fuel cell stack the reactive gas whose pressure is made higher as a moisture content of the fuel cell stack becomes less.
